(19) United States
(12) Patent Application Publication
(10) Pub. No.: US 2026/0075369 A1
(43) Pub. Date: Mar. 12, 2026

(54) Training Machine Learning Algorithms for Steering a Hearing Device

(71) Applicant: SONOVA AG, Staefa (CH)

(72) Inventors: Laurent Simon, Zürich (CH); Hannes Wuethrich, Stäfa (CH); Frédérick Uhlemayer, Stäfa (CH); Ruksana Giurda, Zurich (CH); Fabian Groeger, Rotkreuz (CH); Simone Lionetti, Rotkreuz (CH); Pascal Baumann, Rotkreuz (CH); Ludovic Amruthalingam, Rotkreuz (CH)

(21) Appl. No.: 19/323,231

(22) Filed: Sep. 9, 2025

Related U.S. Application Data
(60) Provisional application No. 63/692,514, filed on Sep. 9, 2024.

(51) Int. Cl. H04R 25/00; G10L 15/06; G10L 15/20

(52) U.S. Cl. CPC H04R 25/505; G10L 15/063; G10L 15/20; H04R 2225/43

(57) ABSTRACT

An exemplary method includes a processor obtaining a first dataset comprising a plurality of recordings each comprising different background noise, obtaining a second dataset comprising a plurality of recordings each comprising speech audio, mixing recordings included in the first dataset with recordings included in the second dataset to generate an acoustic dataset comprising mixed signals, and performing, based on the acoustic dataset, an operation with respect to a machine learning algorithm used by a hearing device to represent sound to a user.

### RELATED APPLICATIONS

The present application claims priority under 35 U.S.C. § 119(e) to U.S. Provisional Ser. No. 63/692,514, filed Sep. 9, 2024, which is incorporated herein by reference in its entirety.

### BACKGROUND INFORMATION

Hearing devices (e.g., hearing aids) are used to improve the hearing capability and/or communication capability of users of the hearing devices. Such hearing devices are configured to process a received input sound signal (e.g., ambient sound) and provide the processed input sound signal to the user (e.g., by way of a receiver (e.g., a speaker) placed in the user's ear canal or at any other suitable location).

Hearing devices may apply various algorithms for processing sound received as input to the hearing device to provide as output to the user. Such algorithms may include algorithms for steering the hearing device for processing speech in a noisy environment. Such processing may present various difficulties, depending on characteristics of both the speech and the noise. As such algorithms are improved, the hearing performance provided to the user may be improved.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary hearing system that may be implemented according to principles described herein.

FIG. 2 illustrates an exemplary implementation of the hearing system of FIG. 1 according to principles described herein.

FIG. 3 illustrates an exemplary hearing device according to principles described herein.

FIG. 4 illustrates an exemplary hearing system according to principles described herein.

FIG. 5 illustrates an exemplary hearing system according to principles described herein.

FIG. 6 illustrates an exemplary method according to principles described herein.

FIG. 7 illustrates an exemplary computing device according to principles described herein.

### DETAILED DESCRIPTION

Systems and methods for training machine learning algorithms for steering a hearing device are described herein. As will be described in more detail below, an exemplary system may comprise a memory storing instructions and a processor communicatively coupled to the memory and configured to execute the instructions to perform a process. The process may comprise obtaining a first dataset comprising a plurality of recordings each comprising different background noise, obtaining a second dataset comprising a plurality of recordings each comprising speech audio, mixing recordings included in the first dataset with recordings included in the second dataset to generate an acoustic dataset comprising mixed signals, and performing, based on the acoustic dataset, an operation with respect to a machine learning algorithm used by a hearing device to represent sound to a user.

By using systems and methods such as those described herein, it may be possible to train machine learning algorithms for steering a hearing device in real-world situations. For example, systems and methods described herein may include generating datasets for training and/or evaluating machine learning algorithms specifically for tasks associated with steering a hearing device, such as context analysis, source analysis, and/or acoustic analysis. Based on the datasets, the machine learning algorithms and/or models may be trained to direct a focus of the hearing device toward a target sound source and/or reduce noise or other audio from sources other than the target sound source.

In this manner, the hearing device may improve sound processing for audio signals from target sound sources, such as enhancing speech audio from a speaker in a noisy environment. Improved steering of the hearing device using machine learning algorithms may improve an operation of a hearing device and hearing performance for the user. Other benefits of the systems and methods described herein will be made apparent herein.

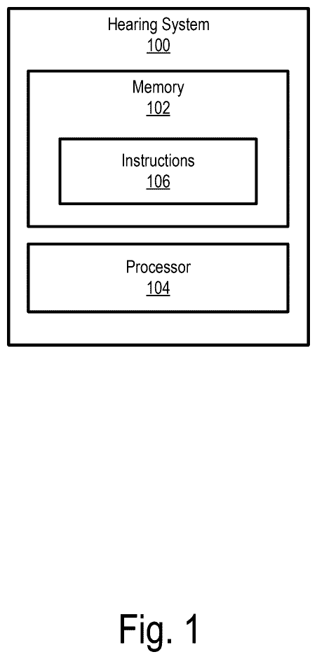

FIG. 1 illustrates an exemplary hearing system 100 (“system 100”) that may be implemented according to principles described herein. As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device such as described herein. In other examples, memory 102 and/or processor 104 may be distributed between multiple devices and/or multiple locations as may serve a particular implementation. Illustrative implementations of system 100 are described herein.

Memory 102 may maintain (e.g., store) executable data used by processor 104 to perform any of the operations described herein. For example, memory 102 may store instructions 106 that may be executed by processor 104 to perform any of the operations described herein. Instructions 106 may be implemented by any suitable application, software, code, and/or other executable data instance.

Memory 102 may also maintain any data received, generated, managed, used, and/or transmitted by processor 104. Memory 102 may store any other suitable data as may serve a particular implementation. For example, memory 102 may store hearing loss profile data, user preference data, setting data, acoustic parameter data, machine learning data, input sound classification data, hearing performance data, graphical user interface content, movement classification data, model data, sensor data, and/or any other suitable data.

Processor 104 may be configured to perform (e.g., execute instructions 106 stored in memory 102 to perform) various processing operations associated with training machine learning algorithms for steering a hearing device. These and other operations that may be performed by processor 104 are described herein.

As used herein, a “hearing device” may be implemented by any device or combination of devices configured to provide or enhance hearing to a user.

For example, a hearing device may be implemented by a hearing aid configured to amplify audio content to a recipient, a sound processor included in a stimulation system configured to apply electrical and acoustic stimulation to a recipient, or any other suitable hearing prosthesis. In some examples, a hearing device may be implemented by a behind-the-ear (“BTE”) housing configured to be worn behind an ear of a user. In some examples, a hearing device may be implemented by an in-the-ear (“ITE”) component configured to at least partially be inserted within an ear canal of a user. In some examples, a hearing device may include a combination of an ITE component, a BTE housing, and/or any other suitable component.

In certain examples, hearing devices such as those described herein may be implemented as part of a binaural hearing system. Such a binaural hearing system may include a first hearing device associated with a first ear of a user and a second hearing device associated with a second ear of a user. In such examples, the hearing devices may each be implemented by any type of hearing device configured to provide or enhance hearing to a user of a binaural hearing system. In some examples, the hearing devices in a binaural system may be of the same type. For example, the hearing devices may each be hearing aid devices. In certain alternative examples, the hearing devices may be of a different type.

In some examples, a hearing device may additionally or alternatively include earbuds, headphones, hearables (e.g., smart headphones), and/or any other suitable device that may be used to facilitate a user perceiving sound in an environment. In such examples, the user may correspond to either a hearing-impaired user or a non-hearing-impaired user.

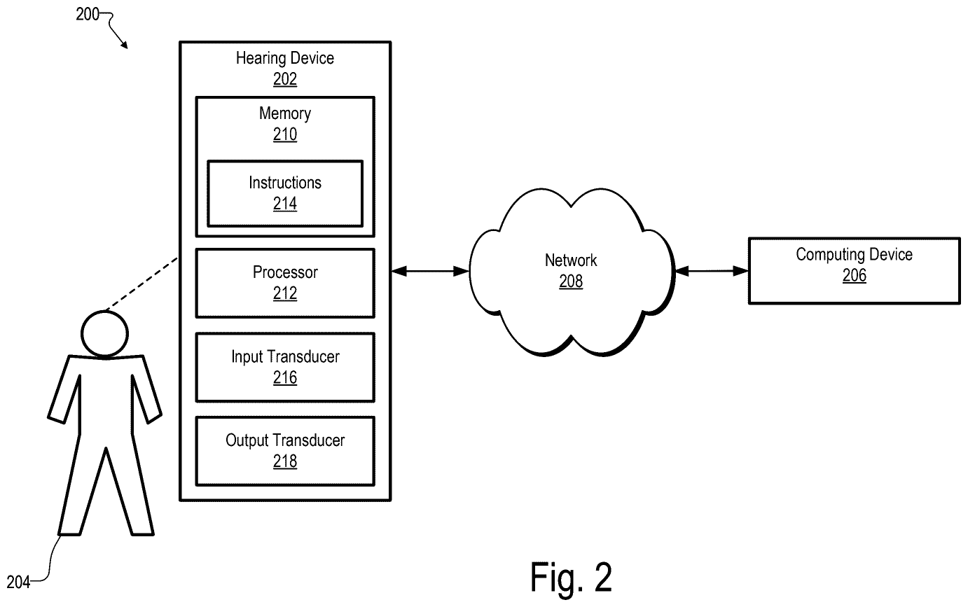

System 100 may be implemented in any suitable manner. For example, system 100 may be implemented by a hearing device and/or a computing device that is communicatively coupled in any suitable manner to the hearing device. To illustrate an example, FIG. 2 shows an exemplary implementation 200 in which system 100 may be provided in certain implementations. As shown in FIG. 2, implementation 200 includes a hearing device 202 that is associated with a user 204 and that is communicatively coupled to a computing device 206 by way of a network 208.

Hearing device 202 may correspond to any suitable type of hearing device such as described herein. Hearing device 202 may include, without limitation, a memory 210 and a processor 212 selectively and communicatively coupled to one another. Memory 210 and processor 212 may each include or be implemented by hardware and/or software components (e.g., processors, memories, communication interfaces, instructions stored in memory for execution by the processors, etc.). In some examples, memory 210 and processor 212 may be housed within or form part of a BTE housing. In some examples, memory 210 and processor 212 may be located separately from a BTE housing (e.g., in an ITE component). In some alternative examples, memory 210 and processor 212 may be distributed between multiple devices (e.g., multiple hearing devices in a binaural hearing system) and/or multiple locations as may serve a particular implementation.

Memory 210 may maintain (e.g., store) executable data used by processor 212 to perform any of the operations associated with hearing device 202. For example, memory 210 may store instructions 214 that may be executed by processor 212 to perform any of the operations associated with hearing device 202 assisting a user in hearing. Instructions 214 may be implemented by any suitable application, software, code, and/or other executable data instance.

Memory 210 may also maintain any data received, generated, managed, used, and/or transmitted by processor 212. For example, memory 210 may maintain any suitable data associated with a hearing loss profile of a user, input sound classifications, sound processing patterns, machine learning algorithms, and/or hearing device function data. Memory 210 may maintain additional or alternative data in other implementations.

Processor 212 is configured to perform any suitable processing operation that may be associated with hearing device 202. For example, when hearing device 202 is implemented by a hearing aid device, such processing operations may include monitoring ambient sound and/or representing sound to user 204 via an in-ear receiver. Processor 212 may be implemented by any suitable combination of hardware and software. In certain examples, processor 212 may correspond to or otherwise include one or more deep neural network (“DNN”) chips configured to perform any suitable machine learning operation such as described herein.

Hearing device 202 may further include an input transducer 216 and an output transducer 218. Hearing device 202 may include additional or alternative components as may serve a particular implementation.

Input transducer 216 may include one or more electroacoustic transducers, e.g., one or more microphones and/or one or more microphone arrays. The one or more microphones may be implemented by one or more suitable audio detection devices configured to detect audio data representative of one or more audio signals presented to a user of hearing device 202. The one or more audio signals may include, for example, audio content (e.g., music, speech, noise, etc.) generated by one or more audio sources included in an environment of the user (e.g., environmental audio/sound). Each microphone may be included in or communicatively coupled to hearing device 202 in any suitable manner.

Additionally or alternatively, input transducer 216 may include a radio frequency (RF) receiver configured to receive RF signals including audio data representative of one or more audio signals presented to the user of hearing device 202. For instance, the RF signals may be received in accordance with a Bluetooth™ protocol and/or by a mobile phone network such as 4G or 5G and/or by any other type of RF communication such as, for example, data communication via an internet connection and/or data communication at a frequency in a GHz range. The audio signal may include, for example, a phone call signal and/or a streaming signal which may be received while delivered from an audio provider, such as a phone call signal provider and/or a streaming media provider and/or may comprise a signal transmitted from a source device, e.g., a smartphone. Each RF receiver may be included in hearing device 202 and/or communicatively coupled to hearing device 202 in any suitable manner.

Output transducer 218 may be implemented by any suitable audio output device, for instance a loudspeaker of a hearing device.

User 204 may be any individual that is a user of a hearing device. Computing device 206 may include or be implemented by any suitable hardware and/or software components (e.g., processors, memories, communication interfaces, instructions stored in memory for execution by the processors, etc.) and may include any combination of computing devices as may serve a particular implementation. In some examples, computing device 206 may be implemented by a mobile phone, a mobile computing device, a tablet computer, a laptop computer, a desktop computer, a server or server system, and/or any other suitable computing device and/or system that may be configured to improve a hearing performance level of the hearing device. In such examples, computing device 206 may be configured to perform any suitable operations such as those described herein.

Network 208 may include, but is not limited to, one or more wireless networks (Wi-Fi networks), wireless communication networks, mobile telephone networks (e.g., cellular telephone networks), mobile phone data networks, broadband networks, narrowband networks, the Internet, local area networks, wide area networks, and any other networks capable of carrying data and/or communications signals between hearing device 202 and computing device 206. In certain examples, network 208 may be implemented by a Bluetooth protocol (e.g., Bluetooth Classic, Bluetooth Low Energy (“LE”), etc.) and/or any other suitable communication protocol to facilitate communications between hearing device 202 and computing device 206. Communications between hearing device 202, computing device 206, and any other device/system may be transported using any one of the above-listed networks, or any combination or sub-combination of the above-listed networks.

System 100 may be implemented by computing device 206 or hearing device 202. Alternatively, system 100 may be distributed across computing device 206 and hearing device 202, or distributed across computing device 206, hearing device 202, and/or any other suitable computing system/device.

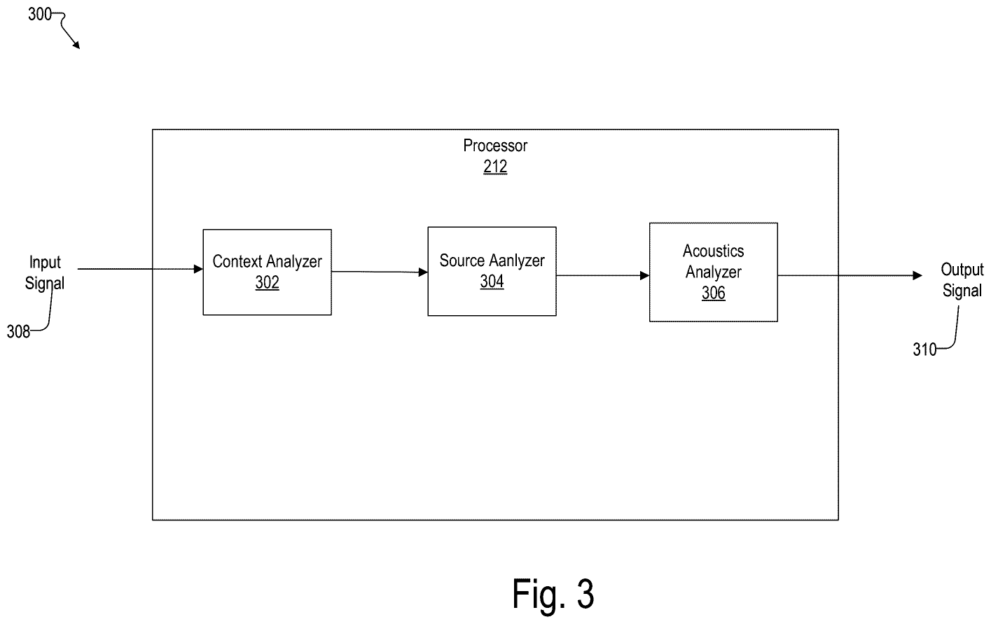

Hearing device 202 may be configured to be optimized for user 204 by applying one or more machine learning algorithms for various functions for processing sound received by hearing device 202 and presented to user 204. For example, FIG. 3 illustrates an exemplary configuration 300 that shows an example implementation of processor 212 of hearing device 202. Processor 212 may include various components that perform various sound processing algorithms and/or functions of one or more sound processing algorithms for steering hearing device 202. For example, processor 212 may include a context analyzer 302, a source analyzer 304, and an acoustics analyzer 306. While shown as separate components in configuration 300, these components may be portions of a same component, additional components, etc. to perform any suitable sound processing operations.

Hearing device 202 may use one or more machine learning algorithms (e.g., a deep learning algorithm and/or any other suitable machine learning algorithm) to implement portions or all of context analyzer 302, source analyzer 304, and acoustics analyzer 306 for steering hearing device 202 (e.g., directing a focus of hearing device 202 toward a target sound source(s) and/or reducing noise or other audio from sources other than the target sound source(s)). For instance, hearing device 202 may use a machine learning algorithm to focus on speech audio from a speaker in a noisy environment. The algorithms may perform various tasks to steer hearing device 202.

For instance, context analyzer 302 may receive an input signal 308, which may include one or more target audio signals mixed with noise and/or non-target audio signals. Context analyzer 302 may classify, based on input signal 308, an environment of user 204. The environment of user 204 may affect how hearing device 202 processes input signal 308 to focus on the target audio signal, which may include enhancing the target audio signal and/or reducing other audio signals. For example, context analyzer 302 may classify whether input signal 308 sounds like user 204 is in an indoor environment or an outdoor environment. Additionally or alternatively, context analyzer 302 may classify whether input signal 308 is likely audio from a stationary environment or a transient environment. Additionally or alternatively, context analyzer 302 may classify a type of audio environment based on input signal 308, such as a type of location and/or a semantic categorization (e.g., a domestic environment, a leisure environment, a nature environment, a professional environment, a transport environment, etc.) or any other such categorization that may present similar acoustic environments for steering hearing device 202 and/or analysis of input signal 308.

Source analyzer 304 may analyze input signal 308 to determine characteristics of the target audio source. For example, source analyzer 304 may detect speech audio, determine a number of speech sources (e.g., a speaker count), determine a direction and/or location of a sound source, apply a beamforming algorithm, and/or perform any other suitable tasks associated with analyzing a source of sound for which hearing device 202 is steering.

Acoustics analyzer 306 may analyze input signal 308 to determine acoustic properties of the target audio signal. For example, acoustics analyzer 306 may determine a signal-to-noise ratio (SNR) of the target audio (e.g., speech audio), a direct-to-reverberant energy ratio (DRR), a reverberation time (RT60), and/or any other suitable properties of the speech audio.

Based on the analysis of context analyzer 302, source analyzer 304, and/or acoustics analyzer 306, processor 212 may process input signal 308 to generate an output signal 310. Output signal 310 may include processed audio signals that may steer hearing device 202 toward the target sound source and provide enhanced audio to improve hearing for user 204.

While conventional hearing devices may apply machine learning algorithms for performing various tasks, conventional machine learning models may not be configured for steering the hearing devices in a real-world environment. Systems and methods described herein include applying machine learning models and algorithms for such tasks.

Further, to train and evaluate such machine learning algorithms and/or models, datasets including various audio signals may be used. However, conventionally available datasets may widely be used for evaluating and/or benchmarking the models, and therefore may result in models that may exploit leaks between training and evaluation data. Systems and methods described herein may include generating the datasets for use in training and/or evaluating machine learning models for effectively steering hearing devices in a real-world environment.

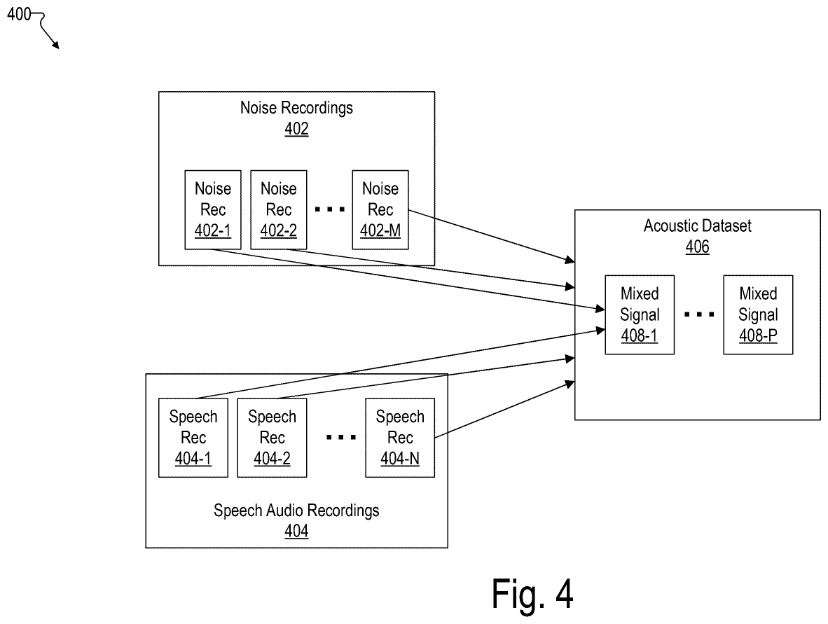

FIG. 4 illustrates an exemplary configuration 400 that shows an example implementation for generating a dataset for training and/or evaluating a machine learning algorithm configured for steering hearing device 202. Exemplary configuration 400 may be implemented by any suitable computing device, such as computing device 206, processor 212 of hearing device 202, an additional computing device communicatively coupled to computing device 206 and/or hearing device 202, any components included therein, and/or any combination or implementation thereof.

Exemplary configuration 400 may include a first dataset that includes a plurality of noise recordings 402 (e.g., noise recording 402-1 through 402-M). Each noise recording 402 may include a recording of any suitable noise audio. Each noise recording 402 may include different background noise, such as noise recordings at different noise levels, noise recordings of different types of noise, noise from different environments (e.g., environments that may be classified by context analyzer 302), different lengths of noise recordings, etc. Noise as used herein may include any audio different from a target audio, such as a target speech audio. In some examples, noise may represent any background sound, such as any background sound that can mask speech and make listening effortful, e.g., traffic, fans, HVAC noise, chatter in a room, footsteps, wind, room reverberation, etc. In some examples, noise may also include specific noise types used in acoustics and audio testing, e.g., pink noise, white noise, impulse noise, speech-shaped noise (SSN), etc.

Computing device 206 may obtain the dataset of noise recordings 402 in any suitable manner. For example, computing device 206 may generate at least a subset of noise recordings 402 by recording audio signals in a plurality of environments. Additionally or alternatively, noise recordings 402 may include samples from an audio library, such as a sound scene library, which computing device 206 may access, receive, etc. in any suitable manner.

Exemplary configuration 400 may further include a second dataset that includes a plurality of speech audio recordings 404 (e.g., speech audio recording 404-1 through 404-N). Each speech audio recording 404 may include a recording of any suitable speech content. Each speech audio recording 404 may include different speech audio recordings, such as speech audio at different levels (e.g., sound pressure levels, vocal effort levels, or any other suitable measure of a level of the speech audio). Additionally or alternatively, each speech audio recording 404 may include different speech audio content, such as recordings of speakers saying different things, different lengths of speech audio, etc. Additionally or alternatively, each speech audio recording 404 may include different acoustic characteristics, such as different types of voices (e.g., different genders, pitches, speeds, etc.) providing speech content.

Computing device 206 may obtain the dataset of speech audio recordings 404 in any suitable manner. For example, speech audio recordings 404 may include samples from an audio library that includes speech audio samples, which computing device 206 may access, receive, etc. in any suitable manner. Additionally or alternatively, computing device 206 may generate at least a subset of speech audio recordings 404 by recording speech of a subject.

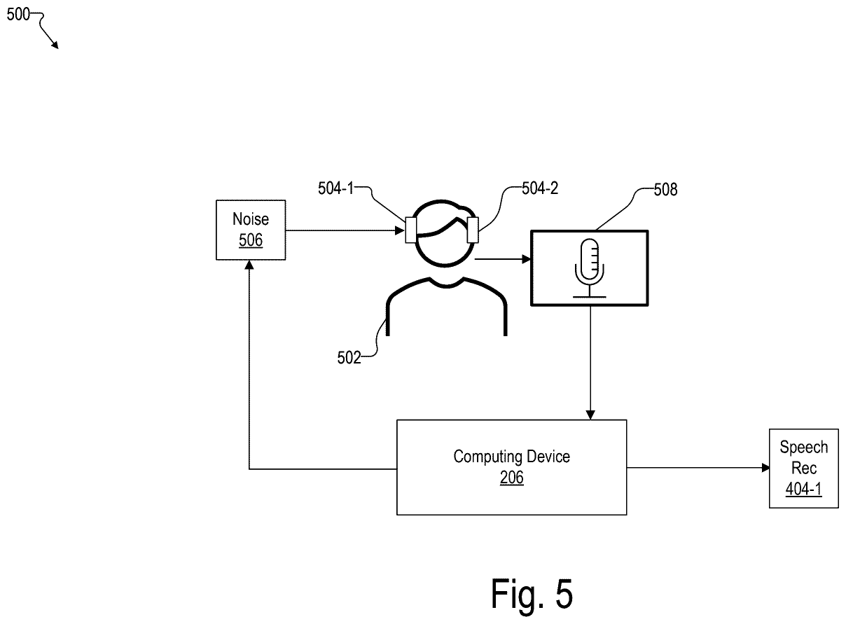

For example, FIG. 5 illustrates an exemplary configuration 500 that shows computing device 206 generating a speech audio recording (e.g., speech audio recording 404-1) by recording a subject 502 speaking. Computing device 206 may generate speech audio recording 404-1 in any suitable manner.

For example, computing device 206 may present to subject 502 via a hearing device 504 (e.g., a binaural hearing device including a first hearing device 504-1 and a second hearing device 504-2) noise 506 while subject 502 speaks and the speech audio is recorded. Noise 506 may be presented at various levels, which may induce (e.g., via a Lombard effect) subject 502 to speak using corresponding various vocal effort levels.

For instance, computing device 206 may present to subject 502 noise 506 at a first level and record (e.g., via a microphone 508), while presenting noise 506 at the first level, speech audio of subject 502 speaking. Based on hearing noise 506 at the first level while speaking, subject 502 may speak at a first vocal effort level. Computing device 206 may record the speech audio at the first vocal effort level and generate speech audio recording 404-1.

Subsequently, computing device 206 may present to subject 502 noise 506 at a second level and record subject 502 speaking with a second vocal effort level, based on the second noise level. Computing device 206 may generate a second speech audio recording based on the second vocal effort level (e.g., speech audio recording 404-2).

As computing device 206 may control the level of noise 506 presented to subject 502, computing device 206 may be able to generate speech audio recordings 404 with known relative vocal effort levels. Computing device 206 may label each speech audio recording 404 with its vocal effort level and use such information in mixing recordings to generate acoustic dataset 406, as further described herein.

Additionally or alternatively, computing device 206 may process the recorded speech audio to generate speech audio recordings 404. For example, computing device 206 may convolve the recorded speech with a set of room impulse responses to generate a plurality of speech audio recordings 404. Each convolution with one or more room impulse responses may generate a speech audio recording 404 with predetermined or known properties of the speech audio. For instance, based on the room impulse response that is convolved with a recorded speech, the resulting speech audio recording 404 may include a particular reverberation level or any other suitable acoustic properties, such as a number of speakers, a position of a speaker, an SNR, a DRR, an RT60, etc. Such information about each speech audio recording 404 may be included or associated with the speech audio recording 404 and used in generating acoustic dataset 406. Such information can then be used, e.g., to label the recordings, or a subset of the recordings, in the acoustic dataset. The labeled recordings may be employed, e.g., for the training of a machine learning algorithm, such as in a supervised and/or semi-supervised training setting. Such information may also be used when evaluating a machine learning algorithm using the recordings, or a subset of the recordings, in the acoustic dataset.

For example, referring back to FIG. 4, computing device 206 may mix recordings included in the first dataset of noise recordings 402 with recordings included in the second dataset of speech audio recordings 404 to generate an acoustic dataset 406 of mixed signals 408 (e.g., mixed signal 408-1 through 408-P). Each mixed signal 408 may be a mix of one or more noise recordings 402 with one or more speech audio recordings 404. For example, computing device 206 may mix noise recording 402-1 and speech audio recording 404-1 to generate mixed signal 408-1.

Computing device 206 may mix noise recordings 402 with speech audio recordings 404 in any suitable manner. For instance, computing device 206 may select a particular noise recording 402 to mix with a particular speech audio recording 404 based on properties of the particular noise recording 402 and/or the particular speech audio recording 404. For example, speech audio recording 404-1 may include speech audio with a first vocal effort level. Noise recording 402-1 may include noise at a first level that corresponds to the first vocal effort level. Based on the matching noise level and vocal effort level, computing device 206 may select noise recording 402-1 and speech audio recording 404-1 to mix to generate mixed signal 408-1. Similarly, computing device 206 may generate another mixed signal (e.g., mixed signal 408-2) by mixing a noise recording (e.g., noise recording 402-2) that may include background noise at a second level with a speech audio recording (e.g., speech audio recording 404-2) that includes speech audio at a second vocal effort level that corresponds to the second noise level.

Additionally or alternatively, computing device 206 may mix noise recordings 402 with speech audio recordings 404 based on any other suitable correlation of noise level and/or vocal effort level. For instance, in addition to or instead of matching noise levels and corresponding vocal effort levels, computing device 206 may mix a first noise level with a second vocal effort level to generate a mixed signal 408 with a predetermined SNR. As another example, mixed signal 408 may be generated with a predetermined DRR. The predetermined properties of the mixed signal may be used to label the recordings, or a subset of the recordings, in the acoustic dataset, e.g., for the training of a machine learning algorithm, or for evaluating a machine learning algorithm.

Additionally or alternatively, computing device 206 may further process noise recording 402 and/or speech audio recording 404 when mixing the recordings to generate mixed signal 408, such as balancing levels, increasing and/or decreasing levels, etc. to generate mixed signal 408 with predetermined properties. Additionally or alternatively, computing device 206 may use known properties of speech audio recordings 404 (e.g., based on the room impulse response convolutions) in selecting particular speech audio recordings 404 to mix with particular noise recordings 402 to generate mixed signals 408 with predetermined properties.

In this manner, computing device 206 may generate a plurality of mixed signals 408 with known and/or predetermined properties that may be included in acoustic dataset 406. Based on acoustic dataset 406, computing device 206 may perform an operation with respect to a machine learning algorithm used by hearing device 202 to represent sound to user 204.

For example, as described, computing device 206 may use acoustic dataset 406 or a subset of acoustic dataset 406 to train a machine learning algorithm to steer hearing device 202. Additionally or alternatively, computing device 206 may use acoustic dataset 406 or a subset of 406 for evaluating the machine learning algorithm, such as for an efficacy in steering hearing device 202.

Training and/or evaluating the machine learning algorithm using acoustic dataset 406 may be performed in any suitable manner. For instance, a first subset of acoustic dataset 406 may be used to train the machine learning algorithm and a second subset of 406 may be used to evaluate the machine learning algorithm. Further, the known or predetermined properties of speech audio in mixed signals 408 may be provided as labels for training and/or evaluating the machine learning algorithm. Further, in some examples, different machine learning algorithms may be applied for different tasks (e.g., context analysis, source analysis, acoustics analysis, etc.) or sub-tasks, for which computing device 206 may perform operations with respect to the different machine learning algorithms based on acoustic dataset 406 as described herein.

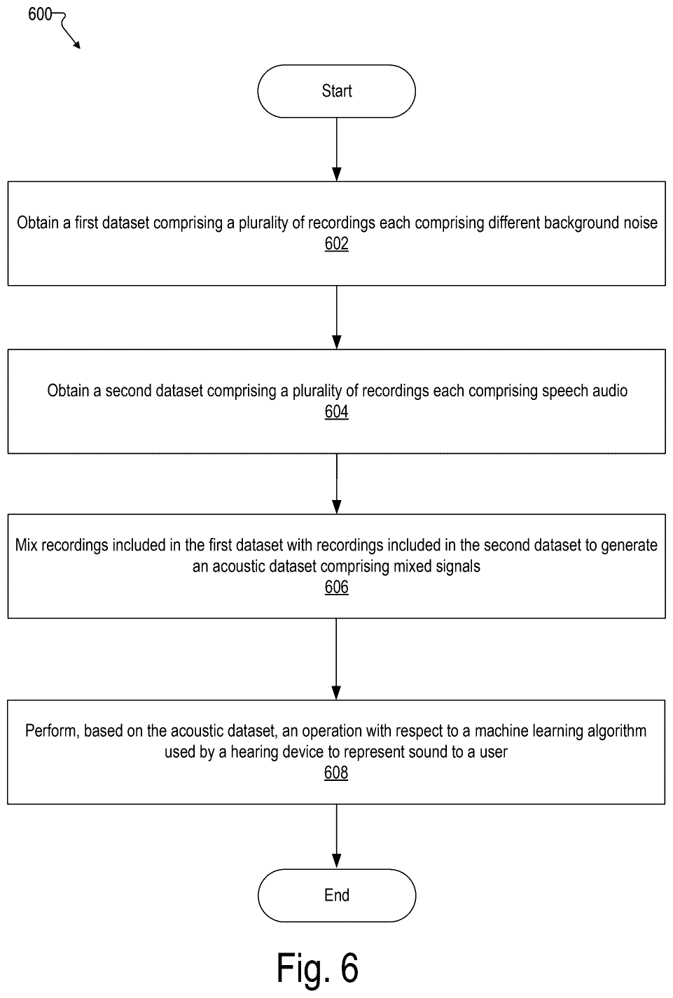

FIG. 6 illustrates an exemplary method 600 for training machine learning algorithms for steering a hearing device according to principles described herein. While FIG. 6 illustrates exemplary operations according to one embodiment, other embodiments may omit, add to, reorder, and/or modify any of the operations shown in FIG. 6. One or more of the operations shown in FIG. 6 may be performed by a hearing device such as hearing device 202, processor 212 of hearing device 202, a computing device such as computing device 206, an additional computing device communicatively coupled to computing device 206 and/or hearing device 202, any components included therein, and/or any combination or implementation thereof.

At operation 602, a processor may obtain a first dataset comprising a plurality of recordings each comprising different background noise. Operation 602 may be performed in any of the ways described herein.

At operation 604, the processor may obtain a second dataset comprising a plurality of recordings each comprising speech audio. Operation 604 may be performed in any of the ways described herein.

At operation 606, the processor may mix recordings included in the first dataset with recordings included in the second dataset to generate an acoustic dataset comprising mixed signals. Operation 606 may be performed in any of the ways described herein.

At operation 608, the processor may perform, based on the acoustic dataset, an operation with respect to a machine learning algorithm used by a hearing device to represent sound to a user. Operation 608 may be performed in any of the ways described herein.

In some examples, a computer program product embodied in a non-transitory computer-readable storage medium may be provided. In such examples, the non-transitory computer-readable storage medium may store computer-readable instructions in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

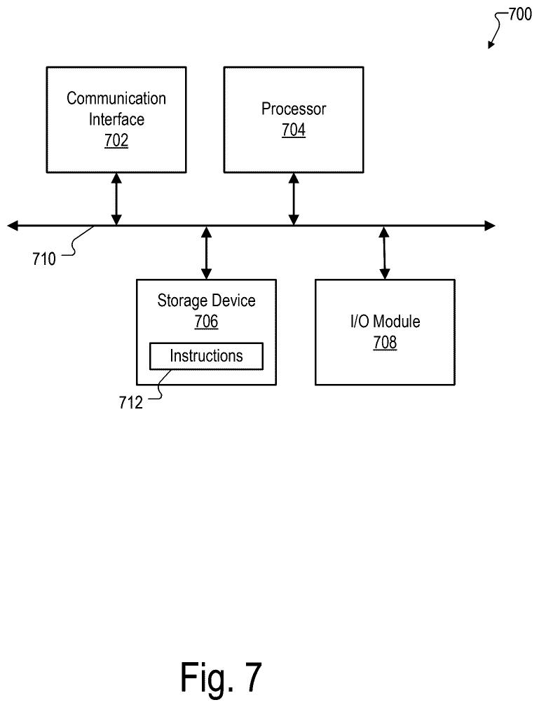

FIG. 7 illustrates an exemplary computing device 700 that may be specifically configured to perform one or more of the processes described herein. As shown in FIG. 7, computing device 700 may include a communication interface 702, a processor 704, a storage device 706, and an input/output (“I/O”) module 708 communicatively connected one to another via a communication infrastructure 710. While an exemplary computing device 700 is shown in FIG. 7, the components illustrated in FIG. 7 are not intended to be limiting. Additional or alternative components may be used in other embodiments. Components of computing device 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data and/or interpreting, executing, and/or directing execution of one or more of the instructions, processes, and/or operations described herein. Processor 704 may perform operations by executing computer-executable instructions 712 (e.g., an application, software, code, and/or other executable data instance) stored in storage device 706.

Storage device 706 may include one or more data storage media, devices, or configurations and may employ any type, form, and combination of data storage media and/or device. For example, storage device 706 may include, but is not limited to, any combination of the non-volatile media and/or volatile media described herein. Electronic data, including data described herein, may be temporarily and/or permanently stored in storage device 706. For example, data representative of computer-executable instructions 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation.

In some examples, any of the systems, hearing devices, computing devices, and/or other components described herein may be implemented by computing device 700. For example, memory 102 and/or memory 210 may be implemented by storage device 706, and processor 104 and/or processor 212 may be implemented by processor 704.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
obtaining, by a processor, a first dataset comprising a plurality of recordings each comprising different background noise;
obtaining, by the processor, a second dataset comprising a plurality of recordings each comprising speech audio;
mixing, by the processor, recordings included in the first dataset with recordings included in the second dataset to generate an acoustic dataset comprising mixed signals; and
performing, by the processor and based on the acoustic dataset, an operation with respect to a machine learning algorithm used by a hearing device to represent sound to a user.

2. The method of claim 1, wherein the performing the operation with respect to the machine learning algorithm comprises training, using at least a subset of the acoustic dataset, the machine learning algorithm to steer the hearing device for processing speech in a noisy environment.

3. The method of claim 1, wherein the performing the operation with respect to the machine learning algorithm comprises evaluating the machine learning algorithm using at least a subset of the acoustic dataset.

4. The method of claim 1, wherein the obtaining the second dataset comprises generating at least a subset of the plurality of recordings comprising speech audio.

5. The method of claim 4, wherein the generating at least the subset of the plurality of recordings comprising speech audio comprises:
presenting, to a subject via an additional hearing device, noise at a first level;
recording, while presenting the noise at the first level, speech audio of the subject speaking at a first vocal effort level to generate a first recording of the subset of the plurality of recordings;
presenting, to the subject via the additional hearing device, noise at a second level; and
recording, while presenting the noise at the second level, speech audio of the subject speaking at a second vocal effort level to generate a second recording of the subset of the plurality of recordings.

6. The method of claim 5, wherein the mixing the recordings included in the first dataset with the recordings included in the second dataset is based on the first vocal effort level and the second vocal effort level.

7. The method of claim 5, wherein the mixing the recordings included in the first dataset with the recordings included in the second dataset comprises:
mixing a third recording included in the first dataset with the first recording, the third recording including background noise at the first level; and
mixing a fourth recording included in the first dataset with the second recording, the fourth recording including background noise at the second level.

8. The method of claim 5, wherein the generating at least the subset of the plurality of recordings comprising speech audio further comprises convolving the first recording and the second recording with a set of room impulse responses to generate additional recordings of the subset of the plurality of recordings, the additional recordings comprising different levels of predetermined properties of the speech audio.

9. The method of claim 8, wherein the properties comprise at least one of signal-to-noise ratio (SNR), direct-to-reverberant energy ratio (DRR), reverberation time (RT60), position, or a number of speakers.

10. A computer program product embodied in a non-transitory computer-readable storage medium and comprising computer instructions for performing a process comprising:
obtaining a first dataset comprising a plurality of recordings each comprising different background noise;
obtaining a second dataset comprising a plurality of recordings each comprising speech audio;
mixing recordings included in the first dataset with recordings included in the second dataset to generate an acoustic dataset comprising mixed signals; and
performing, based on the acoustic dataset, an operation with respect to a machine learning algorithm used by a hearing device to represent sound to a user.

11. The computer program product of claim 10, wherein the performing the operation with respect to the machine learning algorithm comprises training, using at least a subset of the acoustic dataset, the machine learning algorithm to steer the hearing device for processing speech in a noisy environment.

12. The computer program product of claim 10, wherein the performing the operation with respect to the machine learning algorithm comprises evaluating the machine learning algorithm using at least a subset of the acoustic dataset.

13. The computer program product of claim 10, wherein the obtaining the second dataset comprises generating at least a subset of the plurality of recordings comprising speech audio.

14. The computer program product of claim 13, wherein the generating at least the subset of the plurality of recordings comprising speech audio comprises:
presenting, to a subject via an additional hearing device, noise at a first level;
recording, while presenting the noise at the first level, speech audio of the subject speaking at a first vocal effort level to generate a first recording of the subset of the plurality of recordings;
presenting, to the subject via the additional hearing device, noise at a second level; and
recording, while presenting the noise at the second level, speech audio of the subject speaking at a second vocal effort level to generate a second recording of the subset of the plurality of recordings.

15. The computer program product of claim 14, wherein the mixing the recordings included in the first dataset with the recordings included in the second dataset is based on the first vocal effort level and the second vocal effort level.

16. The computer program product of claim 14, wherein the mixing the recordings included in the first dataset with the recordings included in the second dataset comprises:
mixing a third recording included in the first dataset with the first recording, the third recording including background noise at the first level; and
mixing a fourth recording included in the first dataset with the second recording, the fourth recording including background noise at the second level.

17. The computer program product of claim 14, wherein the generating at least the subset of the plurality of recordings comprising speech audio further comprises convolving the first recording and the second recording with a set of room impulse responses to generate additional recordings of the subset of the plurality of recordings, the additional recordings comprising different levels of predetermined properties of the speech audio.

18. The computer program product of claim 17, wherein the properties comprise at least one of signal-to-noise ratio (SNR), direct-to-reverberant energy ratio (DRR), reverberation time (RT60), position, or a number of speakers.

19. A system comprising:
a memory that stores instructions; and
a processor communicatively coupled to the memory and configured to execute the instructions to perform a process comprising:
obtaining a first dataset comprising a plurality of recordings each comprising different background noise;
obtaining a second dataset comprising a plurality of recordings each comprising speech audio;
mixing recordings included in the first dataset with recordings included in the second dataset to generate an acoustic dataset comprising mixed signals; and
performing, based on the acoustic dataset, an operation with respect to a machine learning algorithm used by a hearing device to represent sound to a user.

20. The system of claim 19, wherein the obtaining the second dataset comprises generating at least a subset of the plurality of recordings comprising speech audio, the generating at least the subset of the plurality of recordings comprising speech audio comprising:
presenting, to a subject via an additional hearing device, noise at a first level;
recording, while presenting the noise at the first level, speech audio of the subject speaking at a first vocal effort level to generate a first recording of the subset of the plurality of recordings;
presenting, to the subject via the additional hearing device, noise at a second level; and
recording, while presenting the noise at the second level, speech audio of the subject speaking at a second vocal effort level to generate a second recording of the subset of the plurality of recordings.
